(19) United States
(12) Patent Application Publication
(10) Pub. No.: US 2018/0121963 A1
(43) Pub. Date: May 3, 2018

(54) SYSTEM, METHOD, AND STORAGE MEDIUM FOR GENERATING CONTEXT-AWARE GAME APPLICATION COMPONENT ADVERTISING

(71) Applicant: International Business Machines Corporation, Armonk, NY (US)

(72) Inventors: Inseok Hwang, Austin, TX (US); Su Liu, Austin, TX (US); Eric J. Rozner, Austin, TX (US); Chin Ngai Sze, Austin, TX (US)

(21) Appl. No.: 15/336,527

(22) Filed: Oct. 27, 2016

(51) Int. Cl. G06Q 30/02; A63F 13/335; A63F 13/332; A63F 13/33; A63F 13/32; A63F 13/61

(52) U.S. Cl. CPC G06Q 30/0269; G06Q 30/0275; A63F 13/335; A63F 13/332; A63F 2300/407; A63F 13/32; A63F 13/61; A63F 2300/406; A63F 13/33

(57) ABSTRACT

A system that includes one or more processors including an advertising processor, and a memory storing code that is executable by the one or more processors to determine state information of a first game application and of a second game application, for a mobile computing device. The system communicates the state information to the advertising processor to select an advertisement for display in the second game application, and communicates to the second game application an advertisement for a game component of the first game application, the advertisement selected by the advertising processor in response to receiving the state information. A method and will computer program product corresponding to the apparatus are provided.

### FIELD

The subject matter disclosed herein relates to game applications for mobile computing devices, specifically, a method and apparatus for generating context aware game application component advertising.

### BACKGROUND

Game applications for mobile computing devices are popular among many users. Game application vendors and others advertise game applications in a variety of ways to mobile computing device users.

### BRIEF SUMMARY

In one embodiment, a system is disclosed that includes one or more processors including an advertising processor, and a memory storing code that is executable by the one or more processors to determine state information of a first game application and of a second game application, for a mobile computing device. The system communicates the state information to the advertising processor to select an advertisement for display in the second game application, and communicates to the second game application an advertisement of a game component of the first game application, the advertisement selected by the advertising processor in response to receiving the state information.

In one embodiment, a method is disclosed that includes determining state information of a first game application and of a second game application, for a mobile electronic device. The method further includes communicating the state information to an advertising processor for selecting an advertisement for display in the second game application, and communicating to the second game application an advertisement for a game component of the first game application, the advertisement selected by the advertising processor in response to receiving the state information.

In one embodiment, a program product is disclosed that includes a computer readable storage medium that stores code executable by a processor, the executable code includes code to perform determining state information of a first game application and of a second game application, for a mobile electronic device. The code further performs communicating the state information to an advertising processor to select an advertisement for display in the second game application, and communicating to the second game application the advertisement for a game component of the first game application, the advertisement selected by the advertising processor in response to receiving the state information.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments, and are not therefore to be considered to be limiting of scope, the embodiments will be described and explained with additional specificity and detail through the use of the accompanying drawings, in which:

FIG. 1 is a schematic block diagram illustrating one embodiment of a system for generating context-aware game application component advertising;

FIG. 2 is a schematic block diagram illustrating one embodiment of a mobile computing device for the system of FIG. 1;

FIG. 3A is a schematic block diagram depicting components of a second game application.

FIG. 3B is a schematic block diagram depicting the first game application and an advertisement for components of the second game application.

FIG. 4 depicts example embodiments of game application state information elements;

FIG. 5 depicts example embodiments of user profile elements for providing a user context to the system;

FIG. 6 is a schematic flow diagram of a method for generating context-aware advertising of a second game application component in a first game application; and

FIG. 7 is a schematic flow diagram of a further method for generating context-aware advertising of a second game application component in a first game application.

### DETAILED DESCRIPTION

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly predetermined otherwise. The terms “including,” “comprising,” “having,” and variations thereof mean “including but not limited to” unless expressly predetermined otherwise. An enumerated listing of items does not imply that any or all of the items are mutually exclusive and/or mutually inclusive, unless expressly predetermined otherwise. The terms “a,” “an,” and “the” also refer to “one or more” unless expressly predetermined otherwise.

Furthermore, the described features, advantages, and characteristics of the embodiments may be combined in any suitable manner. One skilled in the relevant art will recognize that the embodiments may be practiced without one or more of the specific features or advantages of a particular embodiment. In other instances, additional features and advantages may be recognized in particular embodiments that may not be present in all embodiments.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk drive (“HDD”), a solid-state disk drive (“SDD”), a random access memory (“RAM”), a read-only memory (“ROM”), an erasable programmable read-only memory (“EPROM” or Flash memory), a static random access memory (“SRAM”), a portable compact disc read-only memory (“CD-ROM”), a digital versatile disk (“DVD”), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the processor of the computer or other programmable data processing apparatus, create means for implementing the functions/acts predetermined in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act predetermined in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts predetermined in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the predetermined logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved.

It will also be noted that each block of the block diagrams and/or flowchart illustration, and combinations of blocks in the block diagrams and/or flowchart illustration, can be implemented by special purpose hardware-based systems that perform the predetermined functions or acts or carry out combinations of special purpose hardware and computer instructions. Blocks or elements, labelled using singular descriptions may include multiple of the blocks of objects in some embodiments. Similarly, blocks, elements, and/or objects labelled using plural form descriptions do not necessarily include a plurality of blocks, elements, and/or objects in some embodiments. Descriptions of Figures may refer to elements described in previous Figures, like numbers referring to like elements.

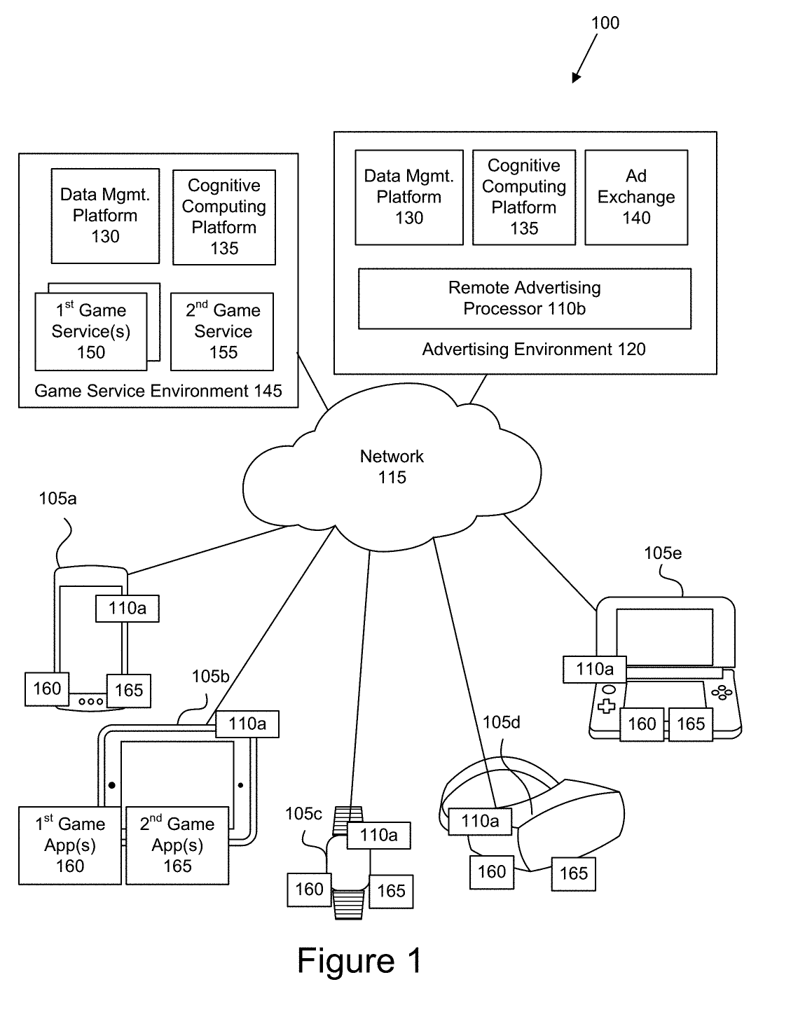

FIG. 1 is a schematic block diagram illustrating one embodiment of a system 100 for generating context-aware game application component advertising. The system 100 improves the field of game-related advertising by providing a method to address deficiencies in existing advertising systems, such as for example, the deficiency that mobile advertisements may often be coarse-grained and typically advertise only a specific product or application.

In existing advertising systems, a user may typically receive an advertisement for an application that is already installed on the user's mobile computing device, thus the advertisement, though relevant, is inefficient since it is advertising an application that has already been installed and may be unlikely to be purchased again for the same device. Thus, by providing a method to advertise components of a game application, rather than merely advertising the game application itself, the system 100 improves the relevance and efficiency of game-related advertising.

In one embodiment, the system 100 includes one or more processors including an advertising processor 110, such as for example, local advertising processor 110a and/or remote advertising processor 110b. The one or more processors may further include a memory storing code that is executable by the one or more processors to determine state information of one or more first game applications 160 and of a second game application 165, for a mobile computing device 105. In some embodiments, the mobile computing device 105 may be one or more of any of a number of types of mobile computing devices. For example, a first type of mobile computing device may be a smart phone 105a. A second type of a mobile computing device may be a tablet 105b. A third type of mobile computing device 105 may be a wearable mobile computing device 105c. A fourth type of mobile computing device may be a virtual reality mobile computing device 105d. A fifth type of mobile computing device 105 may be a mobile game console 105e. These example types of mobile computing devices 105 are merely exemplary and various types of mobile computing devices 105 may be adaptable to play game applications 160, 165.

Mobile computing devices 105 may include various applications, that may also be referred to as apps. Some kinds of apps include phone apps, calendar apps, contact apps, messaging apps, utility apps, navigation apps, browser apps, social media apps, and game apps. Game apps, also known as game applications, may be particularly interesting to some users because they provide opportunities for relaxation, competition, achievement, and to do something engaging while waiting for a particular event such as waiting for an appointment or waiting for a train or waiting for a class to begin.

In some embodiments, or more first game apps 160 and/or one or more second game apps 165 may be obtained by downloading them from application distributors, such as for example, the Google Play′ store or Apple iTunes' store. It may be noted that exemplary embodiments disclosed herein with respect to a first game app and/or a second game may be merely to provide a simplified example and not to limit the number of first game apps 160 and/or second game apps 165 that may be included in the system and methods. In other words, state information from several or many first and second game apps, e.g. 160, 165 may be used to selected and or communication advertising to several or many second game apps 165.

In some embodiments, game apps 160, 165 may be purchased from the application distributors. In some embodiments, game apps 160, 165 may include little or no advertising, while in other embodiments, game apps 160, 165 may include some advertising that may be updated from time to time or even frequently. Some application distributors, such as Google play or Apple iTunes, may advertise to a user based on previous purchases or installations of games purchased by the user.

In further embodiments, game apps 160, 165 are free applications that may be downloaded without payment. In further embodiments, one or more of the game apps 160, 165 may be obtained for free initially. Some of these game apps 160, 165 may offer extended functionality such as additional levels, proprietary features or functionality or virtual goods may be offered within the game app as a user plays the game. In these embodiments, this type of game apps 160, 165 may be referred to as freemium game apps.

In some embodiments, the second game app 165 may communicate with a local advertising processor 110 to communicate an advertisement while a user is playing the second game app 165. If the user wants to accept the offer, he or she may authorize a payment or premium to be paid. The local advertising processor 110 may communicate with the advertising environment 120 over network 115.

It may be noted that while FIG. 1 depicts that the local advertising processor 110a may be present in one or more mobile computing devices 105, such as 105a, 105b, 105c, 105d, in some embodiments the local advertising processor 110 may be present in any number of the mobile computing devices 105 and still operate satisfactorily.

In some embodiments, the mobile computing device 105 may communicate with a network 115. The network 115 may connect to an advertising environment 120. The advertising environment 120 may include a remote advertising processor 110b. The advertising environment 120 may further include, in some embodiments, an ad exchange 140 that provides advertisements to mobile applications over the network 115. The advertising environment 120 may further include a cognitive computing platform 135 that may connect to, and process data from the remote advertising processor 110b, the ad exchange 140, and a data management platform 130, which may each be within or outside of the advertising environment 120.

In some embodiments, advertising processor 110 may be implemented in hardware and/or software on a mobile computing device 105. Moreover, the advertising processor 110 may be implemented as one or more processors that operate within the mobile computing device 105. Additionally, the advertising processor 110 may be implemented as a distributed processor that includes a local advertising processor 110a and a remote advertising processor 110b that communicate across a network 115 so that some of the processing is taking place on the mobile computing device 105 and some of the processing is taking place on one or more processors in the cloud, such as for example in processors included in the advertising environment 120 and/or in a game service environment 145.

The game service environment 145 may include one or more game services such as first game service 150 and second game service 155 that communicate game information such as game characters, scenarios, scores, actions and so forth, over network 115 to the first game app 160 and the second game app 165. In some embodiments that game information may include “real-time” updates of game state. This may be particularly useful for information that is updated frequently by the game service, e.g., 150, 155. For example, in some embodiments exact virtual or real locations of friendly and unfriendly characters, the health of characters, amount of ammunition remaining, and so forth, are all relevant game elements that are likely to be updated frequently. In some embodiments, the game service environment 145 may include and/or communicate with a data management platform 130 and/or a cognitive computing platform 135 that manage and process data from the game services 150,155. The game service environment 145 may communicate with the advertising environment 120 to request or provide data related to advertising related to the first or second game services 150, 155.

In some embodiments, advertising environment 120 may include a remote advertising processor 110b. As used herein, remote refers to the processor being physically remote relative to the mobile computing device 105. The remote advertising processor 110b may operate independently in some embodiments or in other embodiments may operate in conjunction with one or more local advertising processors 110a so as to function as a distributed advertising processor 110 that includes a local advertising processor 110a and a remote advertising processor 110b. The advertising environment 120 may include, or connect to, an ad exchange 140. The ad exchange 140 may initiate a real-time auction to select an advertisement to communicate to the mobile computing device based on the highest bid.

The advertising environment 120 may further include connections to a cognitive computing platform 135. The cognitive computing platform 135 may include various processors and/or systems, each of which may include machine learning capabilities, cognitive computing capabilities, deep neural networks, and other data analytics processing capabilities that enable efficient processing of advertising related data. Moreover, the data management platform 130 and the cognitive computing platform 135 may be the same platforms 130, 135 as used by the game service environment 145 or they may be otherwise shared by the advertising environment 120 and the game service environment 145.

In some embodiments, the cognitive computing platform 135 provides a measure, e.g., a ranking, a score, a successful response estimate, and so forth, for determining which game component of the first game application, e.g., 160 to communicate for advertisement in the second game application e.g., 165. The advertising processor, e.g., 110a may communicate to the cognitive computing platform 135, game app state information, e.g., 400 for all applications related to a particular user. The cognitive computing platform may then analyze the game state for several or all of the user's applications, whether the applications are active or not at a particular time, to further determine a user's preferences.

For example, the cognitive computing platform may determine based on information from several game applications used by the user that the user has a tendency to buy purple items. The first game application 160 may communicate to the advertising processor, e.g., 110a, 110b, a selection of a several candidate game components of the first game application 160 for advertising in the second game application 165.

Using the information from the cognitive computing platform 135 and the provided selection of candidate game components of the first game application 160, the advertising processor, e.g., 110a, 110b may provide a score, a ranking, a successful response estimate, and so forth and to the second game application 165. The second game application 165 may then determine which of the candidate game components to advertise based on the provided measures, such as for example, ranking, score, successful response estimate, etc. This may improve the value of the advertisement by including state information from several or many applications for determining which advertisement to select.

In one embodiment, the data management platform 130 and the cognitive computing platform 135 may include cloud services, such as for example, IBM® Bluemix® that provides a platform for the intersection of games and cognitive computing. IBM® Bluemix® provides tools, services, and infrastructure that may be used to contextualize data in both the game service environment 145 and the advertising environment 120. In some embodiments, cognitive computing services such as IBM® Watson™ services may work in conjunction with Bluemix® services.

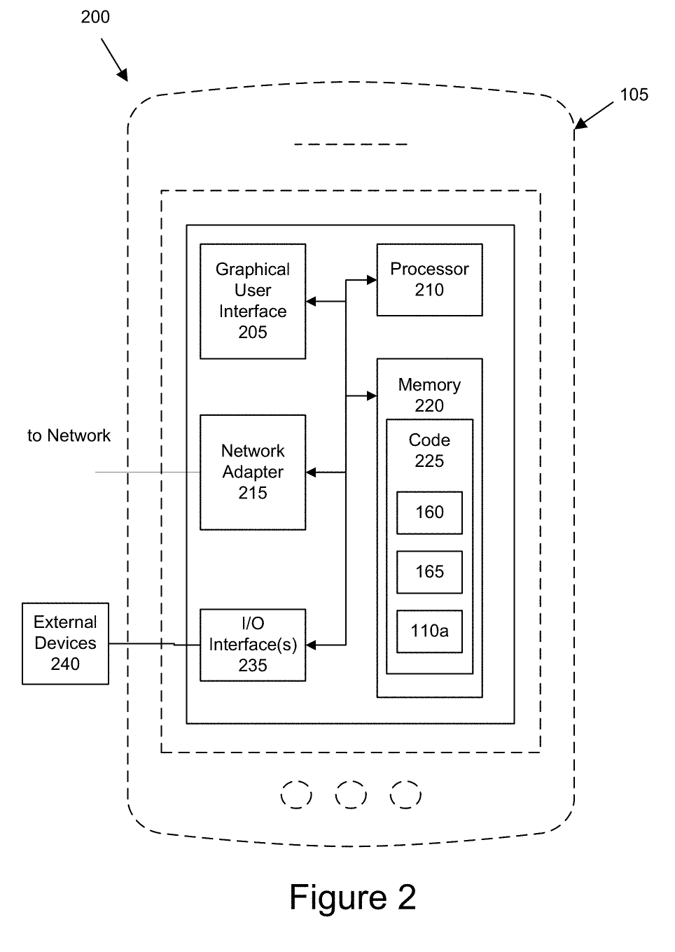

FIG. 2 is a schematic block diagram illustrating one embodiment 200 of a mobile computing device 105 for the system of FIG. 1. The mobile computing device 105 may be any of a number of mobile computing devices that may operate to execute one or more first game apps 160 and a second game app 165. For example, the mobile computing device 105 may be a smart phone 105a, a tablet 105b, a wearable computing device 105c and/or a virtual reality mobile computing device 105d.

The mobile computing device 105, e.g., 105a, 105b, 105c, 105d, may include a processor 210 that communicates with a graphical user interface 205 to display the game apps 160, 165. The mobile computing device may further include one or more memories such as memory 220. The memory 220 may store code 225 that may be executed by processor 210. The code 225 may include one or more first game applications 160 and a second game application 165. The code 225 may further include a local advertising processor 110a that communicates with the first and second game apps 160, 165 and with a remote advertising processor 110b. The processor 210 may communicate with a network adapter 215 that connects to a network, such as for example, network 115.

The local advertising processor 110a may communicate with remote advertising processor 110 over network 115 to act as a distributed advertising processor 110 or in other embodiments to implement a client/server where the local advertising processor 110a access a client and the remote advertising processor 110b acts as a server. In some embodiments, the mobile computing device 105 may include one or more I/O interfaces 235 the communicate with external devices 240, such as for example cameras, displays, audio inputs, audio outputs, and/or other types of sensors.

In some embodiments, game components may enable a first game app 160 or second game app 165 to communicate in a particular way with external devices 240. In some embodiments, game accessories themselves are considered game components that could be advertised in a first game app 160 and/or a second game app 165. For example, in some game apps an external gaming controller, joystick, or control pad may enhance gameplay by giving a user more precise control or faster game action. An advertiser for a first game app 160 that may be enhanced by use of an external game component, such as for example, the accessories described above may choose to advertise that game component in a second game app 165 based on state information received about the first game app 160 and/or the second game app 165.

Moreover, although FIG. 2 depicts a first game app 160 and a second game app 165 as both being present in code 225 of memory 220, in some embodiments the first game app 160 may be present in one mobile computing device 105, such as for example, a smart phone 105a, and the second game app 165 may be installed on a separate mobile computing device, such as for example, a wearable mobile computing device 105c.

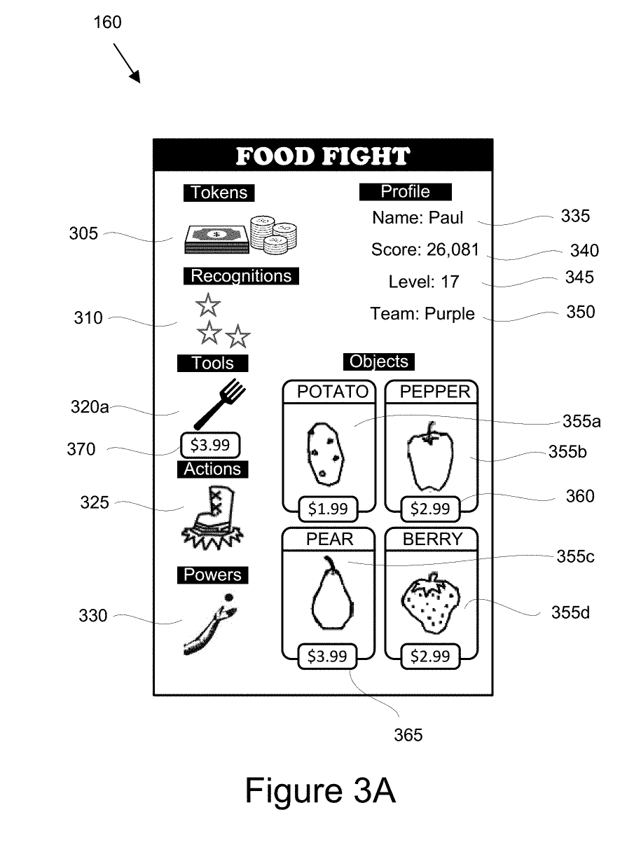

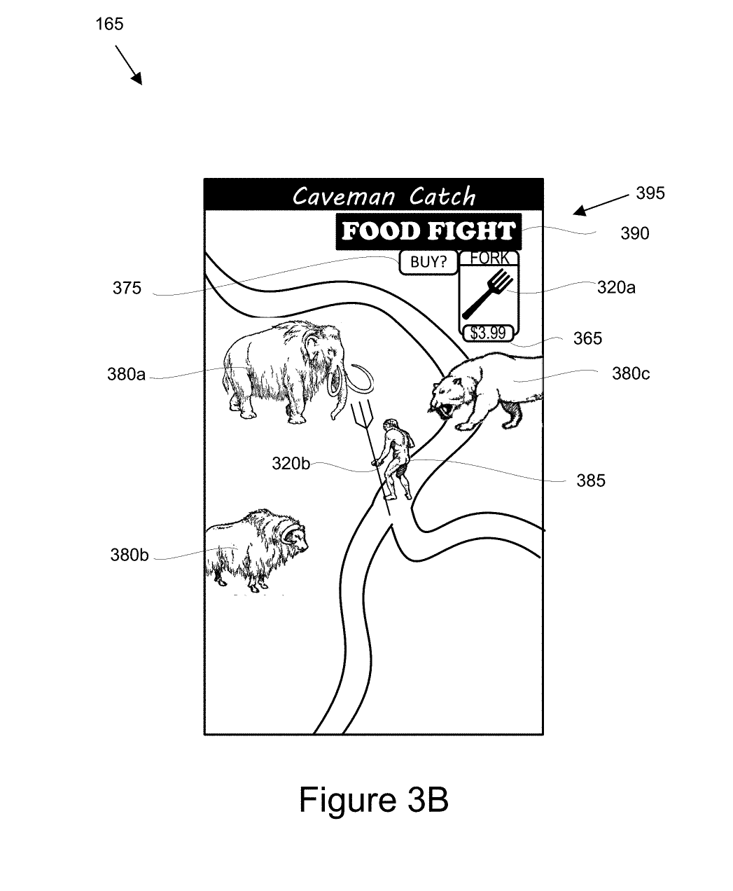

FIG. 3A is a schematic block diagram depicting components of a first game application 160. In one embodiment, the system 100 includes one or more processors including an advertising processor such as advertising processor 110 which may be a single local advertising processor 110a or may be a distributed advertising processor 110 that includes a remote advertising processor 110b. In the embodiment, the system 100 further a memory storing code that is executable by the one or more processors to determine state information of a first game application 160 and of a second game application 165, for a mobile computing device 105. The system 100 may communicate the state information to the advertising processor, e.g., 110a and/or 110b, and further communicate to the second game application 165 an advertisement for a game component of the first game application 160.

In the embodiment, the first game application 160 may include one or more first game applications 160. In other words, in gathering state information for a first game application 160, the processors of the system 100 may gather state information for one or more first game applications 160 rather than limiting state information to that of a single game application 160. In the embodiment, the system 100 further determine state information of the second game application 165. In some embodiments, the state information of the second game application 165 may simply be whether or not the second game application 165 is installed on the mobile computing device 105.

In some embodiments, the first game application 160 may include state information related to various game components of the first game application 160. As used herein game components may refer generally to many different classes of game features relevant to gameplay, rather than referring to for example abstract software modules or technical components related more to the programming of the game than to the gameplay itself. FIG. 3A depicts a number of game components, e.g., 305, 310, 320, 325, and so forth up through 365. The presence or absence of these game components as well as values or types associated with any of the game components may be communicated as part of the state information.

For example, in the example illustrated in FIG. 3A, a first game application 160 relates to a food fight game. Various food objects 355 are depicted, such as for example, a potato 355a, a pepper 355b, a pear 355c, and a berry 355d. A user/player may perform certain actions 325 using the objects 355. For example, a user may stomp on an opponent's berry 355d or throw a pepper 355b at an opponent. The user may further perform such actions 325 using a variety of tools 320. For example, a user may spear a potato 355a with a tool 320 such as a fork. In some embodiments, the user or the object may be endowed with various powers 330. For example, a user may have the power 330 of throwing a food object 355 with great speed, great accuracy, or great distance.

The first game application 160 may further include tokens 305 that a user may earn by accomplishing predetermined game objectives. Similarly, tokens 305 may be earned as a user performs certain actions, such as for example, winning a battle against an opponent. In some embodiments, the tokens 305 may represent a type of virtual currency that a user purchases in exchange for a real-world payment. One example of this type of token 305 may be gold coins in the online game Pokémon Go, in which a user may complete an in-app purchase of tokens whereby a charge is made to a user's predetermined payment account and the user is credited with a predetermined number of tokens 305.

In some embodiments, the first game application 160 may include recognitions 310 which symbolize accomplishments or fulfillments of game objectives by a particular user. For example, a user who selects a variety of foods from four different food groups may earn a recognition 310 for being a health-conscious food fighter. In another example a user may earn a recognition 310 for demonstrating particular adeptness in performing certain types of actions 325 such as throwing, fighting, running, and so forth.

In some embodiments, the game components may include game profile information, such as for example, a name 335 which may include a player's online name or the name selected by a user for a particular character. In some embodiments, the profile may include game components such as team 350 which may further include a team name or a team color. For example, a person named Paul may pick a team color purple because he likes the fact that the word purple starts with P like the name Paul starts with P. In some embodiments, the game components may include a score 340 and or a level 345. The level may simply indicate a level of achievement in some embodiments, or in other embodiments the level may indicate not only achievements but also certain purchases made by user in the game.

For example, in some embodiments a free version of a freemium game may enable a user only to progress to a certain level 345 whereas after making a payment for the game, progression to higher game levels 345 may be enabled. These are merely exemplary embodiments and other well-known games and types of games may have corresponding classes of game components. In some embodiments, the state information of the first game application 160 may include details about any of these game components. Moreover, the details included in the state information may change over time as game play progresses.

In some embodiments, the one or more processors of the system 100 may communicate the state information to the advertising processor 110. As explained above the advertising processor 110, in some embodiments, may include a local advertising processor 110a. In other embodiments, the advertising a remote advertising processor 110b. In further embodiments, the advertising processor 110 includes both a local advertising processor 110a and a remote advertising processor 110b that receive the state information for a second game application 165.

FIG. 3B is a schematic block diagram depicting a second game application 165 and an advertisement 395 for components of the first game application 160 shown in FIG. 3A. For example, as illustrated here, the advertisement 395 may include a header 390 that tells the user the name, e.g., “Food Fight,” of the first game app 165 for which a game component is being advertised. The advertisement 395 may further include an identifier for the game component, e.g., the fork 320a, which was shown as a tool type game component in FIG. 3A. In this embodiment, the state information from the first game application 160 may include the fact that the player or avatar representing the user does not yet have in his or her inventory of tools a fork 320a.

The state information may further include from the second game application 165, the fact that the player 385 or avatar representing the user is particularly adept with using a trident, e.g., 320b. In response to the state information being communicated to the advertising processor 110, the advertising processor 110 may select to advertise a fork 320a game component for the first game application 160 based on the prediction that the player of the second game application may respond to an offer to purchase a game component such as a fork 320a for the food fight game based on his or her success using a fork like tool, e.g., 320b in the second game application 165, e.g., “Caveman Catch.” Similarly, state information 401 may include game objects such as for example, a mammoth 380a, a musk ox 380b, or a sabretooth tiger 380c. In other words, game objects may be abstract or inanimate objects such as a query 375, a price 370, or animate objects, such as a character 385,

For example, in some embodiments, the advertising processor 110 may include a cognitive tool such as clustering, deep neural network processing, and the like, to determine that the fork 320a is a game item in the first game application 160, that closely resembles the trident 320b game item in the second game application 165, and thus select or suggest the fork 320a as a suitable game component from the second game application 165 to advertise in the first game application 160. While the particular game applications, e.g., 160 food fight and 165 caveman catch are merely exemplary depictions. Further examples drawing upon existing game applications may be described.

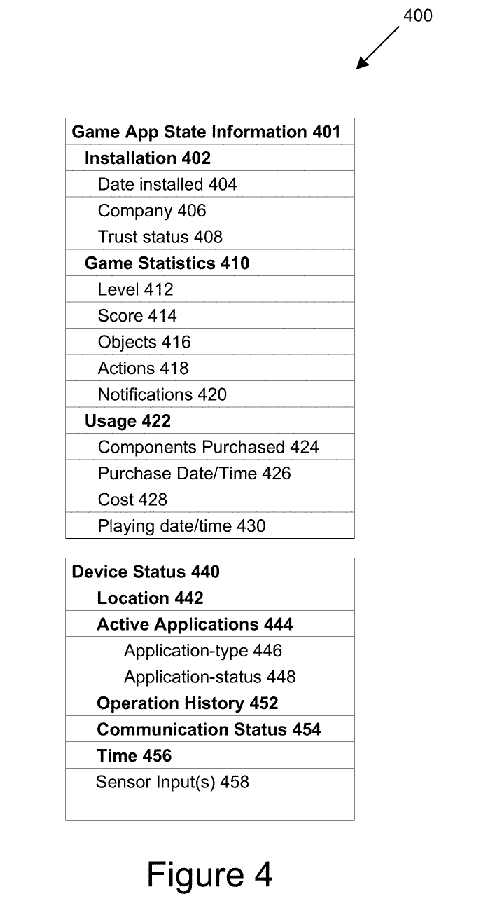

FIG. 4 depicts example embodiments of game application state information 400. In some embodiments, the state information 400 includes game apps state information 401. In some embodiments, the game app state information 401 may include a score 414, a level 412, a purchase 426, a game action 418, a game object 416, a notification 420, an installation status 402, and/or a game company 406. In some embodiments, the state information 400 also includes device status 440. It may be noted that device status 440 standing alone would not be considered state information for the first game app 160 or the second game app 165.

However, the device status 440 in combination with game app state information 401 may be considered state information 400. In other words, the system 100 does significantly more than merely communicating the device status 440 to the advertising processor 110. The system 100 includes code that when executed by one or more processors communicates specific game apps state information 401 for a first game app 160 and a second game app 165 to the advertising processor 110, thus enabling the advertising processor to select an advertisement advertising a game component of the first game app 160 within the second game app 165.

In some embodiments, the game app state information 401 may include installation information 402. The installation information 402 may include for example information about the date a particular game app 160, 165 was installed. In some embodiments, the installed information 402 may include information about the company that produces and/or distributes the game applications 160, 165. In some embodiments, the game apps state information 400 includes a trust status 408.

In some embodiments, the code is executable to determine whether the first game application 160 meets a predetermined trust status for using the state information 400 as a condition for communicating the state information 400 to the advertising processor 110. In some embodiments, the trust status 408 may be set by the user, based on a level of trust that the user assigns to a particular application. For example, a user may assign a lower trust status to a game app that is unfamiliar to him or her.

In some embodiments, once a player has become familiar with a game app he or she may assign a higher trust status. The trust status 408 may have many possible values and need not be limited to a binary trust decision. Moreover, the trust status for weight may be determined in the cloud computing environment. In some embodiments, the first game application 160 may communicate state information 400 to the game service environment 145 and/or to the advertising environment 120. For example, in some embodiments, a user may determine and communicate which game state information to send to the cloud. A user may opt to send all available game state information, a predetermined selection of game state information, or no game state information, in order to facilitate or inhibit receipt of game component advertisements. In other embodiments, a game developer or distributor may determine how much game state information to send. For example, in a freemium game, developer and or distributor may set a trust level that enables a greater amount of game state information to be sent for users playing for free (i.e. using a free version or playing on a free level) and a lesser amount of game state information to be sent where the user has paid money to have more privacy, less game play interruptions, and so forth.

In other embodiments, the game app state information 401 includes a trust status 408 that is determined by the company 406 that produces or publishes the game apps 160, 165. As an example, a first game app 160 could be “Pokémon® Go′ from the Nintendo® company and a second game app 165 could be for example Candy Crush Saga® from King.com which is a wholly-owned subsidiary of Activision® company.

In an illustrative example, the first game app 160, e.g., “Pokémon® Go™” may include a trust status that is recognized by the second game app 165, e.g., Candy Crush Saga® based on cooperation between the two companies 406 who manufacture and/or distribute the respective first and second game apps 160, 165. As used herein, the trust status 408 may refer to any certificate, level, status indicator, or other data used to indicate the level of sharing of state information enabled for a particular app or apps.

In some embodiments, the game app state information 401 may be communicated to the advertising processor for use in selecting an advertisement for the second game app 165 but may be abstracted based on the trust status 408. For example, rather than communicating a specific level 412 that a user/player has achieved, the state information communicated to the advertising processor may indicate whether the user is a beginner, a novice, or an expert.

In some embodiments, the game app state information 401 may include game statistics 410. For example, game statistics 410 may include a level that indicates what level a player has achieved within a certain game. In some embodiments, the level 412 may also indicate whether a user has paid a premium to advance beyond the number of levels included in the free and paid version of the game apps 160, 165.

The game app state information 400 may further include game statistics 410 such as a score 414 for a particular user/game player at a particular time. Other types of game information may be contemplated, such as for example, objects 416 that are possessed by a particular game character or objects 416 that are available within a particular game app. Similarly, the game statistics 410 may include actions 418 taken by a particular game player in a particular game app.

The game statistics 410 may further include notifications 420. In some embodiments, a first game application 160 may receive a notification 420 that a particular game objective has been achieved. In some embodiments, in a first game application 160 a user/player may be seeking to find particular creatures and upon finding a new creature may receive a notification that the player has found a predetermined number of creatures of a particular type.

Referring again to FIGS. 3A and 3B, in some embodiments when a player in the second game app 165, e.g., Caveman Catch finds and dispatches a wild animal 380c, the user/player may receive a notification saying “congratulations, you have prevented a sabretooth tiger from destroying your musk ox herd.” In some embodiments, in response to the game app state information 401 being communicated and including the notification 420, the advertising processor 110 may request an advertisement for an analogous predator/pest game object in the second game app, e.g., the Food Fight game app illustrated in FIG. 3A. For example, the advertising processor 110 may advertise an in-app purchase of bug spray to prevent bugs from eating the player's food.

Each of these elements of state information 400 may be communicated individually or in combination to the advertising processor 110. In some embodiments, a significant portion of the state information 400 may already exist in the cloud, e.g., in game service environment 145. Thus, the state information 400 may be communicated from a first game service 150 and/or a second game service 155 to the data management platform 130 and/or to the cognitive computing platform 135.

These platforms may exist within the game service environment 145 and may communicate with the advertising environment 120 over network 115. Similarly, the data management platform 130 and the cognitive computing platform 135 may be a single platform that is accessed by both the game service environment 145 and the advertising environment 120. Thus, the state information 400 may be communicated to the remote advertising processor 110b very rapidly in this type of cloud computing environment.

In some embodiments, the system includes code to perform a real-time update of the state information from the mobile computing device prior to the advertising processor selecting the advertisement. This can be done in a number of ways. For example, in some embodiments the state information, such as for example, state information 400, which represents the state of a first game application 160 and/or second game application 165 for the mobile computing device 105 may be stored and/or utilized in the game service environment 145 or even in the advertising environment 120 depending on the type of state information 400 included. The state information may further include the elements of the type listed under device status 440.

The remote advertising processor 110b and the other platforms such as data management platform 130 and cognitive computing platform 135 may utilize in-memory processing to facilitate high-speed or even real-time responses. In such embodiments, a real-time update of the state information from the mobile computing device can be easily made prior the advertising processor selecting the advertisement. In other embodiments, at least some of the state information 400 may exist on a memory of the mobile computing device 105.

In some embodiments, the local advertising processor 110a may perform a real-time update of the state information prior and communicate the updated state information 400 to, for example, the remote advertising processor 110b. The updated state information 400′ may be used in real-time to communicate, for example, with the cognitive computing platform 135 or the ad exchange 140 to determine within a matter of milliseconds which advertisements to select.

Because fast response times may be important for a particular first and second game application, e.g., 160, 165, in some embodiments, the real-time updates may be enabled in an efficient manner. The real-time updates of information need not necessarily include all of the state information 400. Rather they may include only updated information relevant to a particular advertising decision. For example, it may not be necessary to state information 400 about every action 418 or every change in score 414 where such state information 400 may be less relevant to an advertising selection decision. Thus, the system 100 may respond quickly to relevant changes in state information by updating the state information prior to sending it to the advertising processor 110 but it may do so efficiently without draining batteries, causing data overages or slowing down gameplay as may be associated if to frequent updates were made to communicate the state information 400 that is less relevant.

In some embodiments, the advertising processor 110a, 110b may determine the frequency and/or the amount of game state information to send based on parameters of the device. For example, if battery is very low, or if the network connection is slower or of intermittent quality, the advertising processor 110a, 110b may send more coarse-grained state information or may send only a limited set of game state information in real-time. When battery or network outlook improves, then the amount and/or the rate of game state information sent may be increased.

FIG. 4 depicts example embodiments of device status 440 which may be used to determine a device context and/or a user context which may be communicated to the advertising processor 110. In some embodiments, the code is executable to further communicate to the advertising processor 110, a user context for the user of the mobile computing device 105. The state information 400 may include information relevant to the game application, e.g., 160, 165, which is not expressly or exclusively part of the game program memory itself.

The term context as used herein may refer to information, that in addition to and separate from the active game app itself, that can be used to characterize the situation of a person, place, or object that is considered relevant to the interaction between a user and one or more game applications, including the user and game applications themselves. A system 100 is context-aware if it uses context to provide relevant advertising information and/or services to the user.

Because a particular mobile computing device 105 may be used by or belong to a particular user, a device status 430 may be included in the user context for any user of the mobile computing device 105. In some embodiments, more than one user context for a single mobile computing device may exist. For example, friends, siblings, and/or coworkers may take turns play games with a mobile computing device 105 by trading the possession of the device back and forth during play, such as for example, in multiuser game applications, e.g., 160, 165. In other embodiments, a single user context for multiple mobile computing devices 105 may exist. For example, a single user may play a game on a smart phone 105a and then at a later time continue playing the same game on a different mobile device such as tablet 105b.

Included in the user context may be a device status 430 which may include for example a location 432 of the mobile computing device at a particular time. To continue with the previous example, if a first game application 160 is for example Pokémon Go® which includes a GPS location feature and a second game application 165 is Candy Crush Saga®, the location 432 of the mobile device may be used for example to determine that the player is nearing a location where a friend or someone else happens to be playing Candy Crush Saga®. Thus, an advertising processor 110 for Candy Crush Saga® may wish to present in the second game application 165, e.g., Pokémon Go®, an in-app advertisement for a game component of Candy Crush Saga®, such as for example, a booster which is a game component that enables a user to score points more readily.

In some embodiments, the user context may be used by the advertising processor, e.g., 110a, 110b to determine which game components from the first game application (e.g. 160) to provide. For example, if a user is jogging between PokeStops' in Pokémon Go®, the advertising processor, e.g., 110a, 110b may determine that the user is running. In response to determining that the user is running, the advertising processor, e.g., 110a, 110b may advertise some magical shoes, or another game component related to running.

In some embodiments, the first game application 160 and the second game application 165 are both present in memory on the same mobile computing device 105. The first game application 160 and/or the second game application 165 may be active applications 444. The active application status 444 may include an application type 446, and/or an activation status 448. The device status 440 may further include operation history 452 beyond merely the operation history of the game app but also the operation history of the mobile device, e.g., mobile computing device 105. The device status 440 may further include a communication status 454, a time 456, and/or sensor inputs 458.

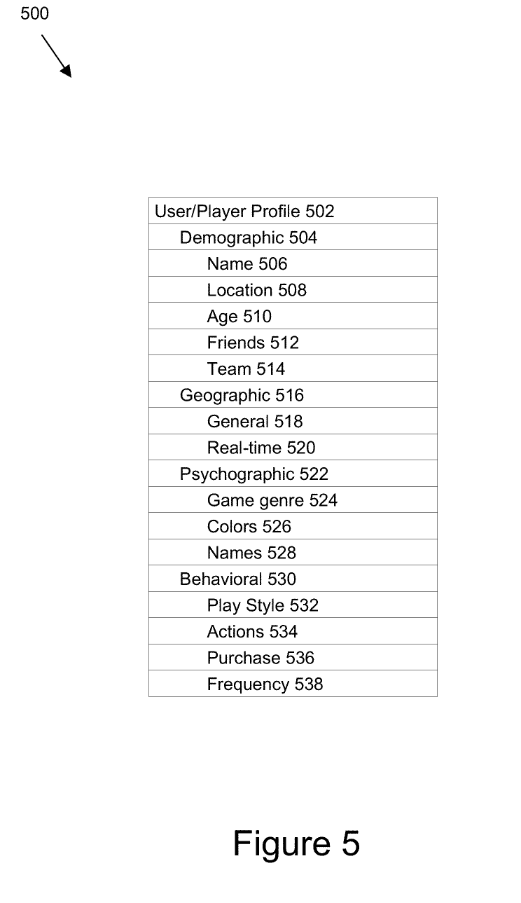

FIG. 5 depicts example embodiments of a user profile 502 that may provide user context to the system 100. In some embodiments, the system 100 includes one or more processors, such as remote advertising processor 110b, that execute code to determine a user context 500 for the user of the mobile computing device 105. In some embodiments, a user profile 502 may include user demographics 504 such as for example, a name 506, a location 508, an age 510, identifying information regarding the user's friends 512, particularly friends who also play the same or similar game applications as the user. In some embodiments, the user profile may include information related a particular team 514.

The system 100 includes code that when executed by one or more processors communicates any number of elements of user profile 502 to the advertising environment 120. The remote advertising processor 110b may communicate information from the user profile 502 that data management platform and/or the cognitive computing platform 135 where the code of the system 100 is executable by one or more processors to perform a segmentation analysis of the user based on the state information 400 and the user context 500.

The segmentation analysis may refer to market segmentation analysis based on factors including demographic 504, geographic 516, psychographic 522, and/or behavioral. It may be noted that the user context 500 alone would not be considered state information of the first game application 160 and the second game application 165, it may nevertheless significantly improve the performance of the advertising processor in selecting the advertisement to communicate to the second game application in response to receiving the state information.

For example, demographic information such as a particular team 514 in the first game application 160 may be used to identify other players on the same team 514 who also play the second game application 165. The advertising processor 110 may then select, for example, to communicate to the second game application 165 an advertisement for a game component of the first game application 160 which is popular among players on the same team 514.

In some embodiments, the segmentation analysis may include geographic 516 information about a user, such as for example, a general location 518 of the user or a real time specific location 520 that may be used by the advertising processor 110 to select an appropriate advertisement by combining the geographic information 516 with the game app state information 401. For example, a game app such as Pokémon Go may use global positioning system (“GPS”) information to determine a real-time location of user, and the system 100 may communicate the real-time location information to an advertising processor such as a remote advertising processor 110b.

In some embodiments, the segmentation analysis may include psychographic 522 information about a user, such as for example, a particular game genre 524 that the user finds appealing, a particular favorite or disfavored color 526, or a tendency to pick character names 528 with a certain sound or appearance. In further embodiments, the segmentation analysis may include behavioral 530 information. For example, a particular style of play such as a preference for aggressive attacking style of gameplay or a patient defensive style of play.

Behavioral 530 information may further include particular actions 534 such as kicking, throwing, swiping, shaking, and so forth. In some embodiments, the actions 534 may reflect actions of the user playing the first and second game applications, e.g., 160, 165. In other embodiments, the actions 534 may reflect actions of characters in the first and/or second game applications. For example, casting of spells with a magic wand may be an action suitably performed by a character but not actually available to the user himself or herself except as provided for in the game applications, e.g., 160, 165.

Behavioral 530 information regarding general user purchase 536 behavior may be useful to the advertising processor to determine an appropriate time to select an advertisement of a particular type. Likewise, information regarding frequency 538 of play and/or of purchases may be usefully communicated to the advertising processor 110 to enable the advertising processor 110 to determine a value for a particular advertisement based on the probability of the user completing a purchase of the advertised game component.

In some embodiments, the system 100 determine a value of the advertisement for use in submitting a bid to the ad exchange 140 which may be a mobile ad exchange, meaning an ad exchange adapted to provide advertisements for mobile computing devices. For example, the data management platform 130, the cognitive computing platform 135 and or the advertising processor 110 may analyze the state information 401, the device status 440, and the user profile 502 and may determine a predicted maximum value for the advertisement based on previously accepted bids for similar sets of data.

In other embodiments, the advertising processor 110 may receive input from a game company, or game distributor that provide a predetermined range of values that an advertiser is willing to pay and the advertising processor 110 may determine merely whether the predicted value of the advertisement for the game component of the first game application 160 is likely to fall within the predetermined range of values when advertised in the second game application 165. In such embodiments, the system 100 may further communicate the advertisement to the second game application, e.g., 165 in response to the bid being accepted.

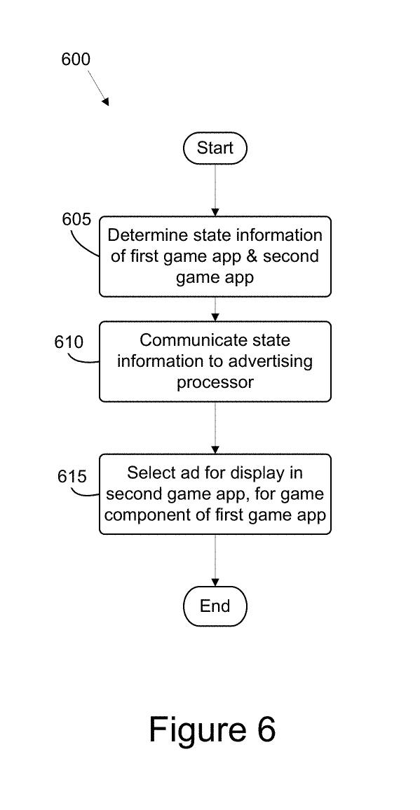

FIG. 6 is a schematic flow diagram of a method for generating context-aware advertising of a second game application component in a first game application. In one embodiment, a method 600 starts and includes determining 605 state information of a first game application and a second game application, for a mobile computing device. In some embodiments, determining 605 the state information may be performed substantially as described above with respect to FIGS. 1 and 2. For example in some embodiments where the state information is generally stored locally, a processor such as processor 210 may access the memory 220 and the code 225 to determine the state information of the first game application 160 and the second game application 165.

In other embodiments, a portion of the state information may be stored in the cloud and may be read in part by one or more processors of the mobile computing device 105 and/or in part by one or more processors within the game service environment 145 and/or the advertising environment 120. In such embodiments, the state information may be determined by the data management platform 130 and/or the cognitive computing platform 135.

The method 600 continues and includes communicating 610 the state information to an advertising processor for selecting an advertisement for display in the second game application. As described above, communicating 610 the state information to the advertising processor 110 may include communicating the state information to a local advertising processor 110a and/or to a remote advertising processor 110b, or in some embodiments, communicating the state information to a distributed advertising processor 110 that includes both local and remote processors.

The method 600 continues and further includes communicating 610 to the second game application an advertisement for a game component of the first game application, the advertisement selected 615 by the advertising processor in response to receiving the state information. In some embodiments, the method 600 communicates 610 to the second game application an advertisement for a game component of the first game application substantially as described above with respect to FIGS. 1-5.

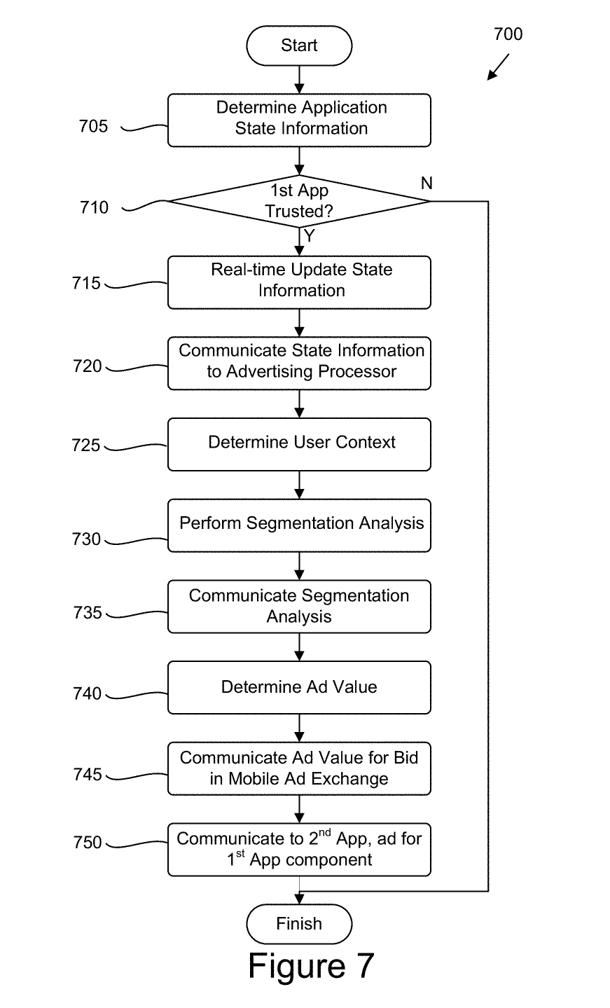

FIG. 7 is a schematic flow diagram of a further method 700 for generating context-aware advertising of a second game application component in a first game application. The method 700 begins and determines 705 state information of a first game application and of a second game application, for a mobile computing device. The state information may be used in carrying out the steps of method 700 and may in some embodiments include a score, a level, an in-app purchase, a game action, a game object inventory, a notification, an installation status, a game company, and or combinations thereof.

In some embodiments, the method 700 determines whether the first game application meets a predetermined trust status for using the state information, as a condition for communicating the state information to an advertising processor. In some embodiments, the method 700 may compare trust information integrated into the first game application with a predetermined trust status to be met.

For example, based on input from a company that produces a second game application, the method may determine that a first game application from a competitor does not meet the trust status sufficient to enable the competitor to advertise in the second application. In some embodiments if the method 700 determines that the first game application does not meet a predetermined trust status, the method 700 does not communicate the state information to an advertising processor and instead terminates.

In other embodiments, the method determines that the first step meets a predetermined trust status sufficient to provide a portion of the state information to the advertising processor. If the method 700 determines 710 that the first application meets at least to some degree a predetermined trust status, the method performs 715 a real-time update of the state information from the mobile computing device prior to the advertising processor selecting the advertisement.

For example, the mobile computing device may perform 715 a real-time update of the state information by communicating information from the mobile device over a network to a cloud service such as data management platform or a cognitive computing platform. In other embodiments, the state information is already stored in high-speed memory the cloud and performing a real-time update of the state information may include accessing the high-speed memory.

In some embodiments, the method 700 communicates 720 the state information to an advertising processor for selecting an advertisement for display in the second game application. In some embodiments, the method 700 determines 725 a user context for the user of the mobile computing device. The user context may include information input to the mobile computing device by the user and/or information determined by a cognitive computing platform from the user's activities related to the game application on the mobile computing device.

In some embodiments, the method 700 performs 730 a segmentation analysis of the user based on the state information and the user context. For example, the segmentation analysis may be performed by a processor within the mobile device or within the cloud, such as for example, by one or more processors in a game service environment and/or in an advertising environment. In some embodiments, the method 700 communicates 735 the segmentation analysis to the advertising processor prior to the advertising processor selecting the advertisement for a game component for the first game application. In some embodiments, the game component

In some embodiments, the method 700 determines 740 a value of the advertisement based on the state information prior to the advertising processor selecting the advertisement. The segmentation analysis and/or the value determination may significantly improve the advertising processors ability to select an appropriate advertisement for the second game application as used by the user.

In some embodiments, the method 700 communicates 745 the value of the advertisement to the advertising processor for use in submitting a bid to a mobile ad exchange. In the embodiments, method 700 further communicates the advertisement to the second game application in response to the bid being accepted. The method 700 further communicates 750 the state information to an advertising processor for selecting an advertisement for display in the second game application; and communicating to the second game application an advertisement for a game component of the first game application, the advertisement selected by the advertising processor in response to receiving the state information. In some embodiments, the game component may be a game object, an add-on, a feature, a feature removal, an extension, an entitlement, an enhancement, an upgrade, and/or combinations thereof.

In some embodiments, one or more steps of method 600 and one or more steps of method 700 may be performed substantially as described above with respect to FIGS. 1-5. In some embodiments, one or more steps of method 600 and/or one or more steps of method 700 may be performed by a program product including a computer readable storage medium that stores code executable by a processor, the executable code comprising code to perform one or more steps of method 600 and/or method 700.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system comprising:
one or more processors including an advertising processor; and
a memory storing code that is executable by the one or more processors to:
determine state information of a first game application for a mobile computing device in response to detecting state information that comprises a gameplay action specific to a second game application for the mobile computing device;
communicate the state information to the advertising processor to select an advertisement for display in the second game application; and
communicate to the second game application an advertisement for a game component specific to gameplay of the first game application for purchase within the second game application but not for gameplay therewithin, the advertisement selected by the advertising processor in response to receiving the state information.

2. The system of claim 0, wherein the code is executable to further determine whether the first game application meets a predetermined trust status for using the state information as a condition for communicating the state information to the advertising processor.

3. The system of claim 0, wherein the code is executable to further perform a real-time update of the state information from the mobile computing device prior to the advertising processor selecting the advertisement.

4. The system of claim 0, wherein the code is executable to further determine a user context for a user of the mobile computing device.

5. The system of claim 4, wherein the code is executable to further perform a segmentation analysis of the user based on the state information and the user context.

6. The system of claim 5, wherein the code is executable to further communicate a least a portion of the segmentation analysis to the advertising processor prior to the advertising processor selecting the advertisement for the game component of the first game application.

7. The system of claim 6, wherein the code is executable to further:
determine a value of the advertisement to use in submitting a bid to a mobile ad-exchange; and
communicate the advertisement to the second game application in response to the bid being accepted.

8. The system of claim 0, wherein the state information comprises game application information selected from the group consisting of a score, a level, a purchase, a game action, a game object, a notification, an installation status, a game company, and combinations thereof.

9. The system of claim 0, wherein the game component is selected from the group consisting of a game object, an add-on, a feature, a feature removal, an extension, an entitlement, an enhancement, an upgrade, and combinations thereof.

10. A method comprising:
determining state information of a first game application for a mobile computing device in response to detecting state information that comprises a gameplay action specific to a second game application for the mobile computing device;
communicating the state information to an advertising processor to select an advertisement for display in the second game application; and
communicating to the second game application the advertisement for a game component specific to gameplay of the first game application for purchase within the second game application but not for gameplay therewithin, the advertisement selected by the advertising processor in response to receiving the state information.

11. The method of claim 10, further comprising determining whether the first game application meets a predetermined trust status for using the state information as a condition for communicating the state information to the advertising processor.

12. The method of claim 10, further comprising performing a real-time update of the state information from the mobile computing device prior to the advertising processor selecting the advertisement.

13. The method of claim 10, further comprising determining a user context for a user of the mobile computing device.

14. The method of claim 13, further comprising performing a segmentation analysis of the user based on the state information and the user context.

15. The method of claim 14, further comprising communicating a least a portion of the segmentation analysis to the advertising processor prior to the advertising processor selecting the advertisement of the game component for the first game application.

16. The method of claim 13, further comprising_determining a value of the advertisement based on the state information prior to the advertising processor selecting the advertisement.

17. The method of claim 16, further comprising:
communicating the value of the advertisement to the advertising processor to use in submitting a bid to a mobile ad-exchange; and
communicating the advertisement to the second game application in response to the bid being accepted.

18. The method of claim 10, wherein the state information comprises game application information selected from the group consisting of a score, a level, an in-app purchase, a game action, a game object inventory, a notification, an installation status, a game company, and combinations thereof.

19. The method of claim 10, wherein the game component is selected from the group consisting of a game object, an add-on, a feature, a feature removal, an extension, an entitlement, an enhancement, an upgrade, and combinations thereof.

20. A program product comprising a computer readable storage medium that stores code executable by one or more processors including an advertising processor to perform:
determining state information of a first game application for a mobile computing device in response to detecting state information that comprises a gameplay action specific to a second game application for the mobile computing device;
communicating the state information to the advertising processor to select an advertisement for display in the second game application; and
communicating to the second game application the advertisement for a game component specific to gameplay of the first game application for purchase within the second game application but not for gameplay therewithin, the advertisement selected by the advertising processor in response to receiving the state information.
